(19) United States
(12) Patent Application Publication
(10) Pub. No.: US 2007/0219856 A1
(43) Pub. Date: Sep. 20, 2007

(54) Method and system of recommending television programs

(75) Inventor: Ty O. Ahmad-Taylor, New York, NY (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/375,306

(22) Filed: Mar. 14, 2006

(51) Int. Cl. G06Q 30/00

(52) U.S. Cl. 705/14

(57) ABSTRACT

Method and system of recommending television programs that may be of interest to a user. The method and system may include configuring a recommendations menu to facilitate user selection of recommended programs. The method and system may track any number of characteristics for the user for use in selecting the recommended programs.

### BACKGROUND OF THE INVENTION

1. Field of the Invention

The present invention relates to methods and system of recommending television programs.

2. Background Art

With the advent of on demand program and other demand based selection techniques, television program providers are better able to deliver user specified content to subscribers. A user interface, electronic programming guide (EPG), or other feature is typically used to facilitate program selection.

One problem faced by television providers relates to which program titles to present to the user for selection. In the past, the user was required to navigate an number of menus and listing in order to select desired content. This can be problematic and inconvenient. However, the television providers are still required to at least initially provide some starting point for user selection.

Accordingly, a need exists for television providers to provide a more convenience process for use in selecting television programs.

### SUMMARY OF THE INVENTION

One non-limiting aspect of the present invention relates to providing recommendations for use in selecting television programs. The recommendations may be used to facilitate selection of television programs likely to be of interest to a user, and thereby, provide a more convenient process for television program selection.

One non-limiting aspect of the present invention relates to a method of recommending television programs. The method may include determining a number of program titles for selection through a user interface and based on a recommendations request for one of the program titles, generating an recommendations menu for use with the user interface.

The method may further include configuring the recommendations menu to include a community rating for the requested program, a playlist of programs associated with the requested program, and a listing of program titles associated with the requested program.

The method may further include generating the community rating, playlist, and listing as a function of parameters listed in a user profile associated with a user making the recommendations request.

The method may further include determining the community rating as a function of ratings submitted by community members associated with the user.

The method may further include determining the community members as a function of individuals selected by the user and/or as a function of individuals having profile parameters corresponding with profile parameters of the user.

The method may further include determining a portion of the user profile parameters as a function of user activity on the Internet and user viewing of cable television programming.

The method may further include determining a portion of the user profile parameters as a function of user specified ratings for content associated with the requested program.

The method may further include configuring the community rating in an easy to understand format by configuring a color-coded number between one and ten, the color-coding and numbering representing the community rating.

The method may further include assigning a different color-coding to each number between one and ten to further facilitate configuring the easy to understand format.

The method may further include configuring a my rating input field within the recommendations menu, the my input rating field providing a color-coded user selectable input field for receiving a user rating for the requested program.

The method may further include configuring the color-coded user selectable input field for ten different color-codes, each color-code being associated with a rating value between one and ten, the user rating corresponding with the selected rating value.

The method may further include simultaneously configuring a community review with the recommendations menu, the community review listing at least one review of a community member for the requested program.

The method may further include determining a color-coded numerical rating and textual review for each review included within the community review, the color-coded rating and textual review being determined as a function of inputs received from the community member associated therewith.

The method may further include determining an agreement value for each of the community reviews, the agreement value indicating the number of community members agreeing with the rating associated with the corresponding community review.

The method may further include configuring a playlist user interface based on a selection of one of the playlists and listing a number of titles associated within the playlist user interface for the selected playlist, each title being selectable to display a recommendations menu. The recommendations menu may include a community rating for a selected title, a playlist of programs associated with the selected title, and a listing of program titles associated with the selected title.

One non-limiting aspect of the present invention relates to another method of recommending television programs. The method may include determining a number of program titles for selection in a user interface and based on a recommendations request for one of the program titles, configuring an recommendations menu within the user interface. The recommendations menu may include recommendations for programs associated with the program title wherein the recommendations are based at least in part on Internet and cable television services consumed by a user making the recommendations request.

One non-limiting aspect of the present invention relates to a system for recommending television programs to a user. The system may include a recommendations server in communication with a user interface and configured to support information display and receipt of user inputs through the user interface. The recommendations server configured to monitor Internet and cable television activities of the user, and based thereon, to instruct the user interface to display a recommendations menu to the user. The recommendations menu may be for use in recommending a number of television programs titles for viewing by the user.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for providing media content in accordance with one non-limiting aspect of the present invention;

FIG. 2 illustrates a recommendations user interface in accordance with one non-limiting aspect of the present invention; and

FIG. 3 illustrates an exemplary playlist user interface in accordance with one non-limiting aspect of the present invention.

### DETAILED DESCRIPTION OF THE PREFERRED EMBODIMENT(S)

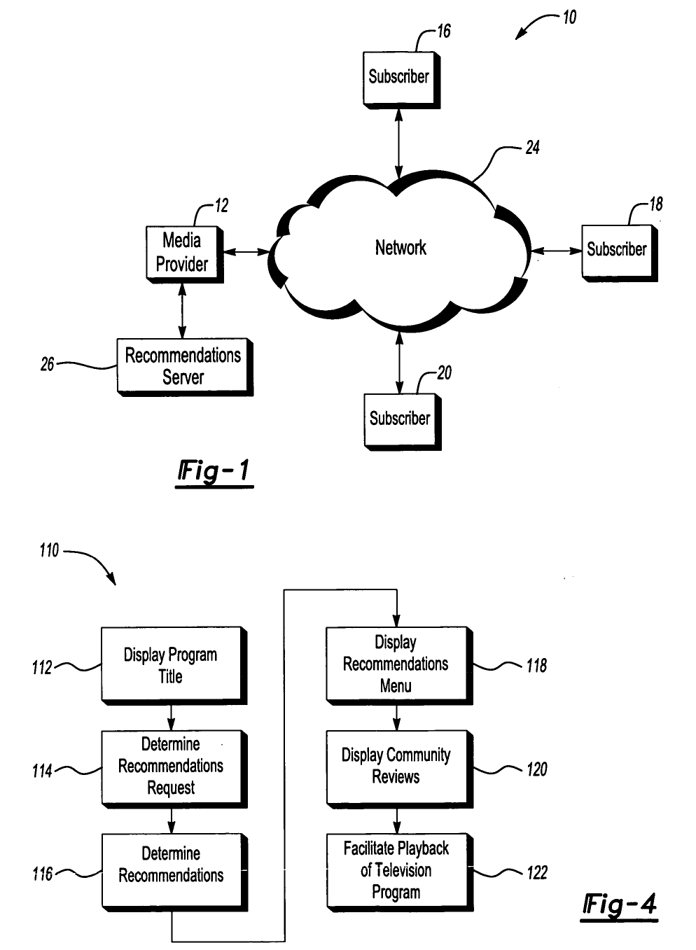

FIG. 1 illustrates a system 10 for providing media content in accordance with one non-limiting aspect of the present invention. The system 10 includes a media provider 12 for providing media services to subscribers 16-20 at one or more subscriber locations and a network 24 for facilitating communications there between.

The media provider 12 may be associated with any number of service providers, such as cable, broadcast, and satellite television, high-speed data, telecommunication, and the like. The media provider 12, for exemplary purpose, is most prominently described with respect to being a cable television service provider having capabilities for providing cable television, telecommunications, and high-speed data services, however, the present invention is not intended to be so limited.

The media provider 12 may be configured to support and/or facilitate the use of any number of television and non-television services and applications, such as, but not limited to, linear and non-linear television programming (cable, satellite, broadcast, etc.), Video on Demand (VOD), interactive television (iTV), interactive gaming, pay-per-view (PPV), digital video recording (local and remote), and others.

The network 24 may include any number of features and devices to facilitate signal transportation and other operations associated with interfacing the subscriber locations with each other and the services associated with the media provider 12. The network 24 may include terrestrial and extraterrestrial components and infrastructures. It may include cable lines, telephone lines, and/or satellite or other wireless architectures. The network 24 may be associated with other private and/or public networks, such as the Internet and provider specific private networks.

For example, one or more of the network support features may be a headend, router, hub, switch, gateway, conditional access router (CARs), cable modem terminations system (CMTSs), network provisioning unit (NPUs), session boarder controller, media gateway, media gateway controller, signaling gateway, call management server, presence server, SIP routing proxy, SIP proxy/registrar server, PCMM policy server, bandwidth on demand server, streaming server caching proxy, gaming server, CDN, media acquisition server, provider server, a unified messaging server, OSS/BSS, global directory server, digital or personal video recorder (DVRs, PVRs), media terminal adapter (MTA), and/or outlet digital adapter (ODA).

Each subscriber location may include one or more media devices to facilitate user interaction with the media content/services. The scope of such interaction may be based on subscriptions and other parameters set by the media provider 12. The subscriptions may specify various classes of services and other parameters associated with usage rights and services available to the corresponding subscriber.

The media devices may relate to any number of devices suitable for interfacing and/or facilitating interfacing the subscribers, For example, the media devices may be a settop box (STB), digital video recorder (DVR), personal computer (PC), television (which may include embedded user interface and processing capabilities), outlet digital adapter (ODA), media terminal adapter (MTA), cable modem (CM), personal digital assistant (PDA), computer, mobile device (phone, computer, etc.), and any other item having capabilities to supporting access to any number of services.

The media devices may be configured to descramble and to support and/or facilitate the use of any number of television and non-television related signals, such as, but not limited to, Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

The system 10 may be used to provide media content to one or more of the subscribers 16-20, as briefly mentioned above. The media content may relate to live and/or on-demand viewing/streaming/broadcasting of television programs, movies, audio, and other multimedia, as well as, downloading of clips or full-length versions of the same, all of which for exemplary purposes may be generally referred to as television programs. The source of this content may be the media provider 12 (which in turn may receive the content from other sources) and/or one or more of the subscriber devices or other non-subscriber devices connected the network 24.

For example, if the media provider 12 is a television service provider, a portion of the media content may relate to television programs, movies, and other multimedia packets. This content may be delivered from the media service provider 12 to the subscribers through streaming, downloading, broadcast, peer-to-peer, and any number of other processes. The media content may be delivered directly from the media service provider and/or from one or more of the other devices in communication therewith.

In more detail, as is common with larger media content providers, multiple regional enterprises, such as headend units and the like, may be configured to provide regional programming to a number of subscribers associated therewith. Each of the headends may store various types of media content for distribution to the subscribers it services. Optionally, the headends may be configured to support headend to headend communications such that non-direct subscribers that are supported by other headends may similarly receive content.

In addition, some of the media content may be sourced from the subscribers 16-20 themselves, such as by transporting content stored locally on the home networks of the subscribers to other locations within the same home network and/or to other locations beyond the home network that may be in communication thereto by way of the network 24. The media provider 12 may include features and capabilities to facilitate such inter-subscriber communications.

Furthermore, the media content provider 12 may include software, applications, and other logic to facilitate the distribution and playback of the media content between any of the features, devices, and elements within the system 10. In accordance with one non-limiting aspect of the present invention, the system 10 may include a recommendations server 26 to facilitate recommending media content to the subscribers.

The recommendations server 26 may include any number of features to facilitate recommending television programs to the subscribers 16-20. As described below in more detail, the recommendations server 26 may be configured to monitor subscriber activities and to generate recommendations as a function thereof. The recommendations may be optionally included within a user interface, programming guide, or other subscriber accessible feature.

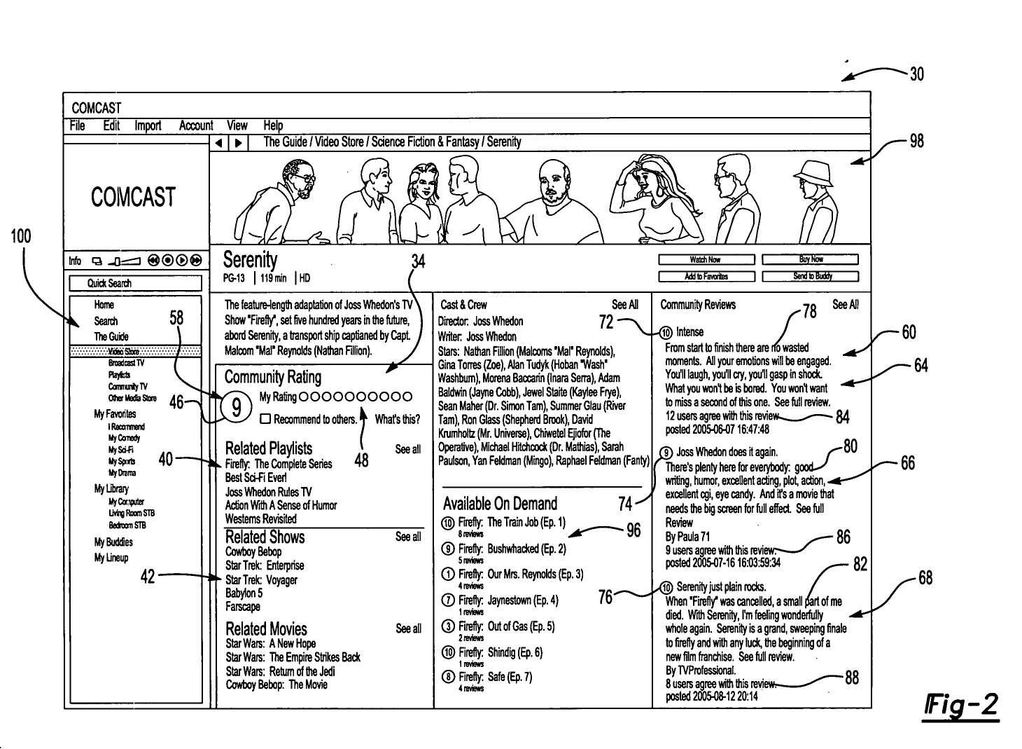

FIG. 2 illustrates a recommendations user interface 30 in accordance with one non-limiting aspect of the present invention. The user interface 30 may be generated as a function of instructions provided from the recommendations server 26 to a media device of the subscriber 16. For example, the recommendations user interface 30 may be displayed on a computer and/or television of the subscriber 16. The instructions associated therewith may be manipulated by a user interface application operating on the computer and/or television (optionally, the television may include STB or other feature to facilitate displaying the user interface).

The recommendations user interface 30 may be accessed from any number of user interfaces associated with the media provider 12, such as through a webpage used by the subscribers to view available content, a electronic television guide or electronic programming guide (EPG) used with a STB to order VOD and to perform other operations, and/or though any other portal or access point reachable by the subscribers 16-20.

Once accessed, the recommendations user interface 30 may be used to recommend television programs to the accessing subscriber 16. As shown, the recommendations user interface 30 has be accessed by way of the subscriber selecting a particular program title from another user interface or otherwise requesting information for the program title, which for exemplary purposes is shown to be a television program entitled “Serenity”.

The recommendations user interface 30 may display a recommendations menu 34 for the selected title. The recommendations menu 34 may include a rating portion 38, a playlist portion 40, and a related content portion 42. These portions may be used in combination and/or independently in making recommendations to the subscriber.

In more detail, the rating portion 38 includes a community rating 46 for the selected title. The community rating 46 may be determined as a function of ratings submitted by a particular community for the selected title. The community may be associated with the subscriber 16 and its members may be determined according to any number of parameters and variables, as described below in more detail.

The rating portion 38 may further include a my ratings input field 48. The input field 48 my be used to receive a rating value from the subscriber 16. The rating values for one or both of the community ratings 46 and subscriber ratings 48 may be based on an easy to understand number/color scheme. In more detail, color-coded values may be associated with numerical values for use in generating the ratings.

As shown in the my ratings input field 48, ten color-coded values may be assigned to a number between one and ten. Each number may represent a rating for the selected titles, such as with one being the worst and ten being the best. The further association of these numerical rating values with the color-coded values may be used consistently throughout all ratings shown in the user interface in order to further facilitate ease of use and quick recognition. The subscriber may input their rating by simply selecting one of the color-coded values.

The playlist portion 40 may be used to recommend a number of playlist having content associated with the selected title and/or otherwise believed to be of interest to the subscriber. Each of the playlists may be selected to display a corresponding user interface having a listing of television programs associated therewith.

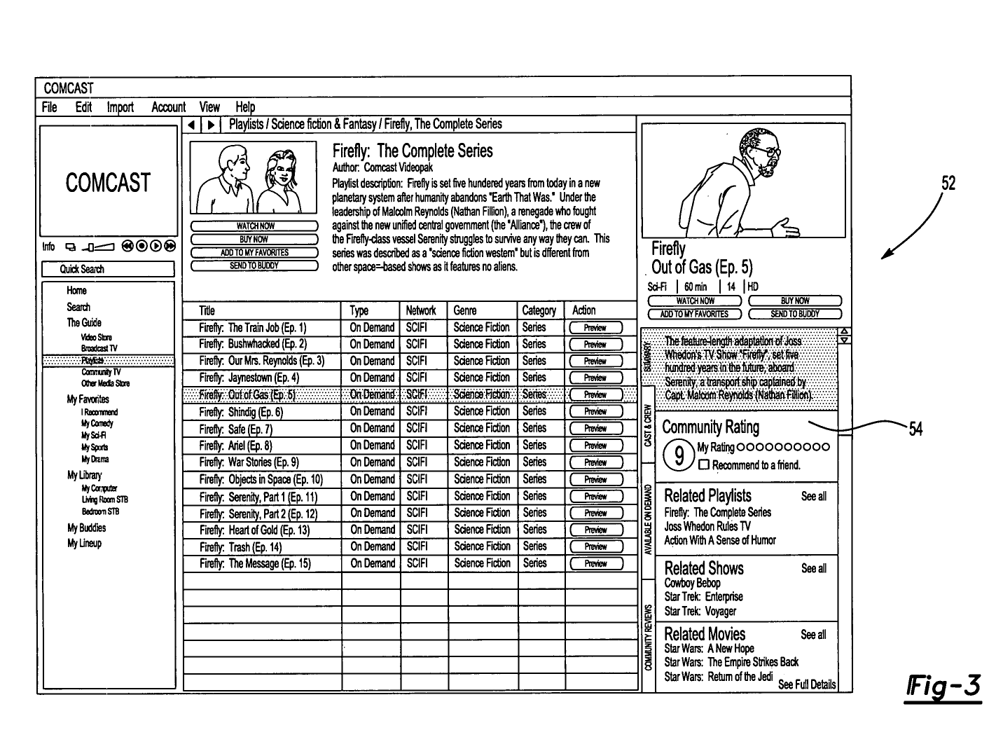

FIG. 3 illustrates an exemplary playlist user interface 52 that may appear with selection of the playlist entitled “Firefly: The Complete Series”. The playlist user interface 52 may include a selectable listing of titles associated with the selected playlist such that each title may itself be selected to facilitate playback of the television program associated therewith.

Optionally, the titles may be highlighted to display another recommendations menu 54. The recommendations menu 54 may include one or more of the features associated with the recommendations menu shown above with respect to FIG. 2. This recommendations menu 54 may serve a similar purpose in making recommendations to the subscriber 16 for titles selected from the playlist user interface 52.

Returning to FIG. 2, the related content portion 42 may used to recommend a number of program titles (shows, movies, etc.) having content associated with the selected title and/or otherwise believed to be of interest to the subscriber 16. The titles listed therein may be selected in a manner similar to that described above with respect to the playlist portion such that a corresponding user interface (not show) is displayed upon the selection thereof. This user interface may then display additional information for the newly selected title, including another recommendations menu like that described above with respect to FIG. 3.

The recommendations user interface 30 may include a community review portion 60. The community review portion 60 may list a number of community reviews 64-68 submitted by a number of community members. Each community review may include a color-code numerical rating 72-76 and textual review 78-82. The color-coded numerical ratings 72-76 may be of the type describe above and selected by the member submitting the community review.

The textual reviews 78-82 may include a textual description of the associated members review. Optionally, a full view link may be provided to review longer portions of the textual review and/or a contact link may be provided to contact the member, such as through email. Still further, an agreement value 84-88 may be associated with each of the community reviews 64-68 in order to illustrate the number of community members agreeing with the rating and/or textual review associated therewith.

The recommendations user interface 30 may include an on demand portion 96 for recommending television programs available on demand. The on demand portion 96 may used to compliment the titles listed in the recommendations menu. For example, at least in some cases, the title listed in the recommendations menu 34 may not be available for on demand viewing but listed therein for use with digital recording operations, DVD purchasing, and other time-delay or non-instantaneous access such that the on demand portion can be used to indicate one or more recommended television programs that are actually available on demand.

Optionally, each television program listed within the on demand portion 96 may be associated with a color-coded numerical rating value. This may be done to quickly and easily display the community rating for the titles. While not shown, the recommendations menu 34 may include similar community ratings (color-code numerical rating values) for each title listed therein.

In addition to the foregoing community and recommendations features, the recommendations user interface 30 may include any number of other items, features, and elements to facilitate any number of other operations and navigation capabilities.

For example, the user interface 30 may include a graphical caption portion 98 for displaying static or moving images associated with the selected titles. “Watch Now”, “Buy Now”, “Add to Favorites”, and “Send to Buddies” buttons may be include to respectively tune to the selected title, order the selected title, add the selected title to a favorites menu, and to send the title to a friend or other community member.

In addition, the user interface 30 may include a source portion 100 to return to listings of other television programs associated with the sources thereof. As shown, the source portion includes a home, search, guide, favorites, library, buddies, and lineup link. Each of these links may be selected to change the user interface to show television titles associated therewith, and/or, as in the case of the guide, favorites, and library links, expanded to further navigate to specific content source lists.

Importantly, each of the links and user interfaces accessible through the links may be further associated with the recommendations and community features of the present invention such that the subscriber 16 may navigate thereto and receive recommendations and community reviews in a manner similar to that shown with respect to FIG. 2. In this manner, the present invention may be adapted to operate with any user interface in order to make recommendations and display community reviews, and is not necessarily limited to presenting such features through the recommendations user interface.

FIG. 4 illustrates a flowchart 110 of a method of recommending television programs in accordance with one non-limiting aspect of the present invention. One or more aspects of the method and logic associated with performing the operations associated therewith may be embodied in and executed according to instructions included on the recommendations server 26 and/or other feature or computer readable medium included with the system 10.

Block 112 relates to display a number of television program titles to a subscriber. The program television titles may relate to any number of media and multi-media services offered by the media provider 12. The titles may be displayed on a user interface of a television connected by cable, satellite, or other medium, on a computer connected to the internet, and/or some other media devices having a user viewable interface.

Optionally, the television program listing may be displayed as a function of signals received from the recommendations server and/or from some other feature in the system, such as a programming guide server (not shown). In this manner, the recommendations server 26 may be part of the system 10 and/or contacted by the system 10 as needed.

Block 114 relates to determining a recommendations request for one of the television programs displayed in Block 112. The recommendations request may be determined based on user selection of one or the program titles and/or through some other means. The recommendations request relates to a desire to display recommendations for the selected title and need not necessarily require any additional information to be requested.

Block 116 relates to determining recommendations for the selected title. The recommendations may be determined as a function of any number of parameters and variables. For example, the recommendations server 26 may be configured to monitor subscriber activities and to determining viewing habits and preferences as a function thereof. The recommendations server 26 may then consult these preferences and viewing habits to recommend television programs to the subscriber. As such, the content associated with the selected program and habits/preference of the subscriber 16 may be consider when making the recommendations.

Optionally, the recommendations server 26 and/or other feature in the system 10 may be configured to monitor Internet and non-Internet activities of the subscriber. If the media provider 12 provides both high-speed data and television services (VOD, linear and non-linear broadcasting, gaming, pay-per-view/purchase, etc.), the media provider 12 may be in a position to monitor subscribe activities over different mediums, such as accessed webpages, web purchase, videos ordered on demand, programs downloaded over the Internet and/or recorded on DVRs, information selected on web search engines or through EPGs, and the like.

This information may then be used by the recommendations server 26 in making the recommendations. The recommendations server 26 may create a user profile for each subscriber for storing parameter indicative of the subscribers' viewing habits and preferences. The user profile may then be consulted to make the recommendations. For example, the recommendations server 26 may review metadata and other indicators associated with the selected title, along with the parameters specified in the user profile, to make the recommendations.

Block 118 relates to displaying a recommendations menu after determining the recommendations in Block 116. The recommendations menu, as described above, may include any number of features for communicating the recommendations to the user, including the community ratings and related content recommendations. The recommendations server 26 may be configured to generate instructions or other signals suitable for controlling the user interface to display the recommendations.

Block 120 relates to displaying community reviews for the selected titles. The community reviews, as described above, may include any number of features for community reviews of the selected content. The reviews may be submitted by community members deemed to be in the same community as the subscriber. This community membership may be determined by subscriber selection, some form of user profile matching, content of the selected titles, and/or according to any number of other parameters and variables.

Block 122 relates to facilitating playback of the selected title. The playback may occur through the medium used to access the user interface and/or other medium. For example, if the user interface is accessed through a STB, then playback may commence therethrough. Alternatively, if the subscriber 16 may access the user interface through a computer and receive playback through the computer and/or through the STB, such as if the subscriber 16 orders a program for home viewing while accessing the Internet from a remote location.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of recommending television programs, the method comprising:
determining a number of program titles for selection through a user interface; and
based on a recommendations request for one of the program titles, generating an recommendations menu for use with the user interface, the recommendations menu including:
(i) a community rating for the requested program;
(ii) a playlist of programs associated with the requested program; and
(iii) a listing of program titles associated with the requested program.

2. The method of claim 1 further comprising generating the community rating, playlist, and listing as a function of parameters listed in a user profile associated with a user making the recommendations request.

3. The method of claim 2 further comprising determining the community rating as a function of ratings submitted by community members associated with the user.

4. The method of claim 3 further comprising determining the community members as a function of individuals selected by the user and/or as a function of individuals having profile parameters corresponding with profile parameters of the user.

5. The method of claim 2 further comprising determining a portion of the user profile parameters as a function of user activity on the Internet and user viewing of cable television programming.

6. The method of claim 2 further comprising determining a portion of the user profile parameters as a function of user specified ratings for content associated with the requested program.

7. The method of claim 1 further comprising configuring the community rating in an easy to understand format by configuring a color-coded number between one and ten, the color-coding and numbering representing the community rating.

8. The method of claim 7 further comprising assigning a different color-coding to each number between one and ten to further facilitate configuring the easy to understand format.

9. The method of claim 7 further comprising configuring a my rating input field within the recommendations menu, the my input rating field providing a color-coded user selectable input field for receiving a user rating for the requested program.

10. The method of claim 9 further comprising configuring the color-coded user selectable input field for ten different color-codes, each color-code being associated with a rating value between one and ten, the user rating corresponding with the selected rating value.

11. The method of claim 1 further comprising simultaneously configuring a community review with the recommendations menu, the community review listing at least one review of a community member for the requested program.

12. The method of claim 11 further comprising determining a color-coded numerical rating and textual review for each review included within the community review, the color-coded rating and textual review being determined as a function of inputs received from the community member associated therewith.

13. The method of claim 12 further comprising determining an agreement value for each of the community reviews, the agreement value indicating the number of community members agreeing with the rating associated with the corresponding community review.

14. The method of claim 1 further comprising configuring a playlist user interface based on a selection of one of the playlists and listing a number of titles associated within the playlist user interface for the selected playlist, each title being selectable to display a recommendations menu, the recommendations menu including:
a community rating for a selected title;
a playlist of programs associated with the selected title; and
a listing of program titles associated with the selected title.

15. A method of recommending television programs, the method comprising:
determining a number of program titles for selection in a user interface;
based on a recommendations request for one of the program titles, configuring an recommendations menu within the user interface, the recommendations menu including recommendations for programs associated with the program title wherein the recommendations are based at least in part on Internet and cable television services consumed by a user making the recommendations request.

16. The method of claim 15 further comprising configuring the recommendations menu to include:
a community rating for the requested program;
a playlist of programs associated with the requested program; and
a listing of program titles associated with the requested program

17. A system for recommending television programs to a user, the system comprising:
a recommendations server in communication with a user interface and configured to support information display and receipt of user inputs through the user interface, the recommendations server configured to monitor Internet and cable television activities of the user, and based thereon, to instruct the user interface to display a recommendations menu to the user, the recommendations menu for use in recommending a number of television programs titles for viewing by the user.

18. The system of claim 1 wherein the recommendations server is configured to instruct the user interface to display a television guide menu having a listing of a number of selectable program titles, and upon selection of one of the program titles, to display the recommendations menu for the selected title.

19. The system of claim 18 wherein the recommendations menu includes:
a community rating for a selected title;
a playlist of programs associated with the selected title; and
a listing of program titles associated with the selected title.

20. The system of claim 19 wherein the community rating includes an easy to understand format having a color-coded number between one and ten, the color-coding and numerical value representing the community rating.

21. The system of claim 20 wherein the recommendations menu includes a my rating input field, the my input rating field providing a color-coded user selectable input field for receiving a user rating for the requested program.

22. The system of claim 21 wherein the recommendations server receives the user rating for use in generating the community rating for the selected title such that the community rating is used for other members of a corresponding community.

23. The system of claim 21 wherein the color-coded user selectable input field includes ten different color-codes, each color-code being associated with a rating value between one and ten, the user rating corresponding with the selected rating value.

24. The system of claim 19 wherein the recommendation server instructs the user interface to simultaneously display a community review with the recommendations menu, the community review listing at least one review of a community member for the selected title.

25. The system of claim 24 wherein the community review includes a color-coded numerical rating and textual review for each review, the color-coded rating and textual review being determined as a function of inputs received from the community member associated therewith.

26. The system of claim 24 wherein the community review includes an agreement value with each of the community reviews, the agreement value indicating the number of community members agreeing with the rating associated with the corresponding community review.
